(19) United States
(12) Patent Application Publication
(10) Pub. No.: US 2007/0282850 A1
(43) Pub. Date: Dec. 6, 2007

(54) METHOD AND SYSTEM FOR MEDIA CONTENT DISTRIBUTION

(75) Inventor: Marc Sachnoff, Los Angeles, CA (US)

Correspondence Address: SACHNOFF & WEAVER, LTD., 10 SOUTH WACKER DRIVE, CHICAGO, IL, 60606-7507, US

(73) Assignee: Marc J. Sachnoff, Los Angeles, CA (US)

(21) Appl. No.: 11/421,287

(22) Filed: May 31, 2006

(51) Int. Cl. G06F 17/30

(52) U.S. Cl. 707/10

(57) ABSTRACT

This patent discloses a media distribution and marketing system to create a plurality of virtual distribution networks (VDNs) to provide media content to a plurality of subscribers of the VDNs, and provides a method of enhancing the subscriber base of the VDNs. The system delivers content sample packs to subscribers as well as to potential subscribers and provides an opportunity to the potential subscribers to become a member of the VDNs. Moreover, the system may also facilitate an opportunity to subscribers of the VDNs to refer additional subscribers to the VDNs.

### FIELD

This patent relates to the field of media content distribution and specifically, this patent relates to distributing content over communication networks.

### BACKGROUND

Technology in the computer, electronics and communication industries have made tremendous progress over the last few decades. Subsequently, technology used to generate, communicate and use information or media content has increased manifolds. Generally speaking, while consumers' access to information has also increased substantially, the consumers are also inundated by a vast amount of information. As a result, on the consumers' part, it is becoming increasingly difficult to select the right content that the consumers may be interested in. For the content generators, it is difficult to reach the consumers due to increased competition.

Use of various content delivery devices such as wireless phones, personal data assistants (PDAs), digital media players, etc., are ubiquitous in today's society. For example, there are over 190 million wireless phones in use in North America and that number is increasing exponentially. Moreover, the cost of delivering content to consumers using the wireless phones has been steadily decreasing. These and other similar trends will only increase the choices available to consumers for content, including audio content such as music, video content such as television programs, news, etc. On the other hand it will be more and more competitive for content generators and content distributors to reach the consumers who may be potentially interested in their content. Therefore, there is a need for providing a system and/or method that would allow content distributors to identify and reach a selected set of consumers who may be interested in their content.

### BRIEF DESCRIPTION OF THE DRAWINGS

While the appended claims set forth the features of the present patent with particularity, the patent, together with its objects and advantages, may be best understood from the following detailed description taken in conjunction with the accompanying drawings, of which:

FIG. 1 illustrates an example block diagram of a network that may be used to implement an embodiment of the system and method disclosed herein;

FIG. 2 illustrates an example block diagram of a virtual distribution network (VDN) system described herein;

FIG. 3 illustrates an example flow diagram of a content distribution and referral process used by the VDN system of FIG. 3; and

FIG. 4 illustrates an example flowchart of an alternate content distribution and referral program used by the VDN system of FIG. 3.

### DETAILED DESCRIPTION

This patent discloses a media distribution and marketing system to create a plurality of virtual distribution networks (VDNs) to provide media content to a plurality of subscribers of the VDNs, and provides a method of enhancing the subscriber base of the VDNs. The system delivers content sample packs to subscribers as well as to potential subscribers and provides an opportunity to the potential subscribers to become a member of the VDNs. Moreover, the system may also facilitate an opportunity to the subscribers of the VDNs to refer additional subscribers to the VDNs.

In the description that follows, the VDN is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the computing device in a manner well understood by those skilled in the art. The data structures where data are maintained are physical locations of the memory that have particular properties defined by the format of the data. However, while the patent is being described in the foregoing context, it is not meant to be limiting as those of skill in the art will appreciate that several of the acts and operations described hereinafter may also be implemented in hardware.

Turning to the drawings, wherein like reference numerals refer to like elements, the patent is illustrated as being implemented in a suitable networking environment. The following description is based on illustrated embodiments of the patent and should not be taken as limiting the patent with regard to alternative embodiments that are not explicitly described herein.

### Network and Computer

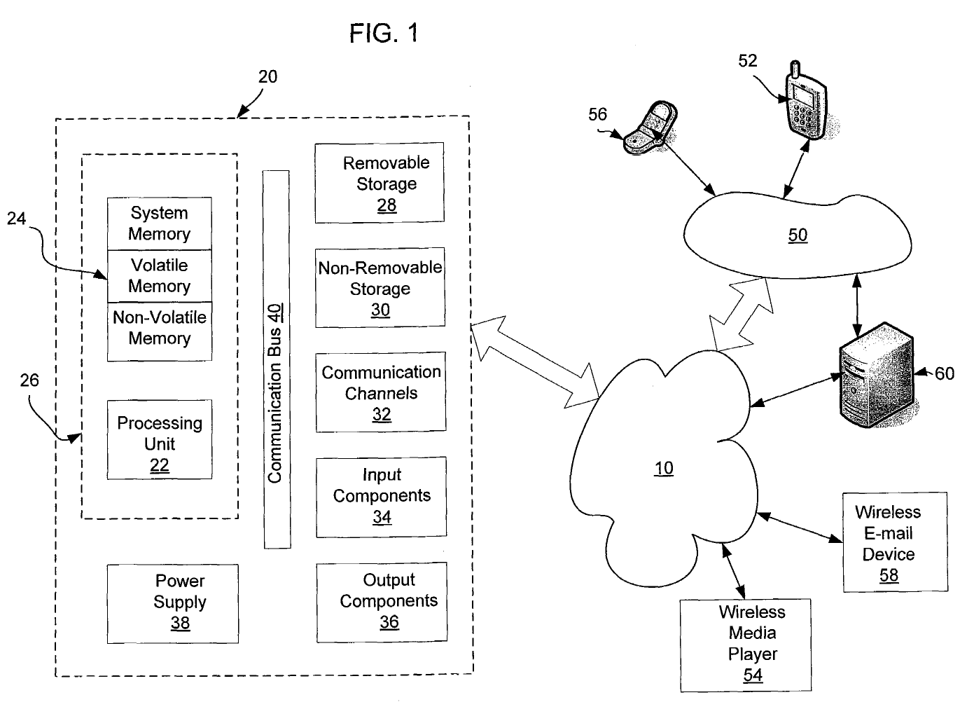

FIG. 1 illustrates a block diagram of a network 10 that may be used to implement the system and method described herein. Each node of the network 10 may reside in a device that may have one of many different computer architectures. For descriptive purposes, FIG. 1 shows a schematic diagram of an exemplary architecture of a computing device 20 usable at any of the various devices connected to the network 10. The architecture portrayed is only one example of a suitable environment and is not intended to suggest any limitation as to the scope of use or functionality of various embodiments described herein. Neither should the computing devices be interpreted as having any dependency or requirement relating to any one or combination of components illustrated in FIG. 1. Each of the various embodiments described herein is operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, the computing device 20 typically includes at least one processing unit 22 and memory 24. The memory 24 may be volatile (such as RAM), non-volatile (such as ROM and flash memory), or some combination of the two. This most basic configuration is illustrated in FIG. 1 by the dashed line 26. The computing device 20 may also contain storage media devices 28 and 30 that may have additional features and functionality. For example, the storage media devices 28 and 30 may include additional storage (removable and non-removable) including, but not limited to, PCMCIA cards, magnetic and optical disks, and magnetic tapes. Such additional storage is illustrated in FIG. 1 by the removable storage 28 and the non-removable storage 30.

Computer-storage media may include volatile and non-volatile, removable and non-removable media implemented in any method or technology for storage of information such as computer-readable instructions, data structures, program modules, or other data. Memory 24, removable storage 28, and non-removable storage 30 are all examples of computer-storage media. Computer-storage media include, but are not limited to, RAM, ROM, EEPROM, flash memory, other memory technology, CD-ROM, digital versatile disks, other optical storage, magnetic cassettes, magnetic tapes, magnetic disk storage, other magnetic storage devices, and any other media that can be used to store the desired information and that can be accessed by the computing device.

The computing device 20 may also contain communication channels 32 that allow it to communicate with other devices. Communication channels 32 are examples of communications media. Communications media typically embody computer-readable instructions, data structures, program modules, or other data in a modulated data signal such as a carrier wave or other transport mechanism and include any information-delivery media. The term computer-readable media as used herein includes both storage media and communications media. The computing device 20 may also have input components 34 such as a keyboard, mouse, pen, a voice-input component, and a touch-input device. Output components 36 include screen displays, speakers, printers, and rendering modules (often called “adapters”) for driving them. The computing device 20 has a power supply 38. Various components of the computing device may communicate with each other via an internal communications bus 40. All these components are well known in the art and need not be discussed at length here.

The network 10 may also be communicatively connected to one or more of a plurality of other devices and/or to another network. For example, the network 10 is illustrated to be communicatively connected to another network 50 that may be for example, a virtual private network (VPN), a local area network (LAN), a wireless metropolitan area network MAN), etc. Additionally, the network 10 may also be communicatively connected, directly or via the another network 50, to a personal data assistant (PDA) 52, a wireless media player 54, a wireless phone 56, a wireless e-mail device 58, a database server 60, etc.

### Content Distribution System

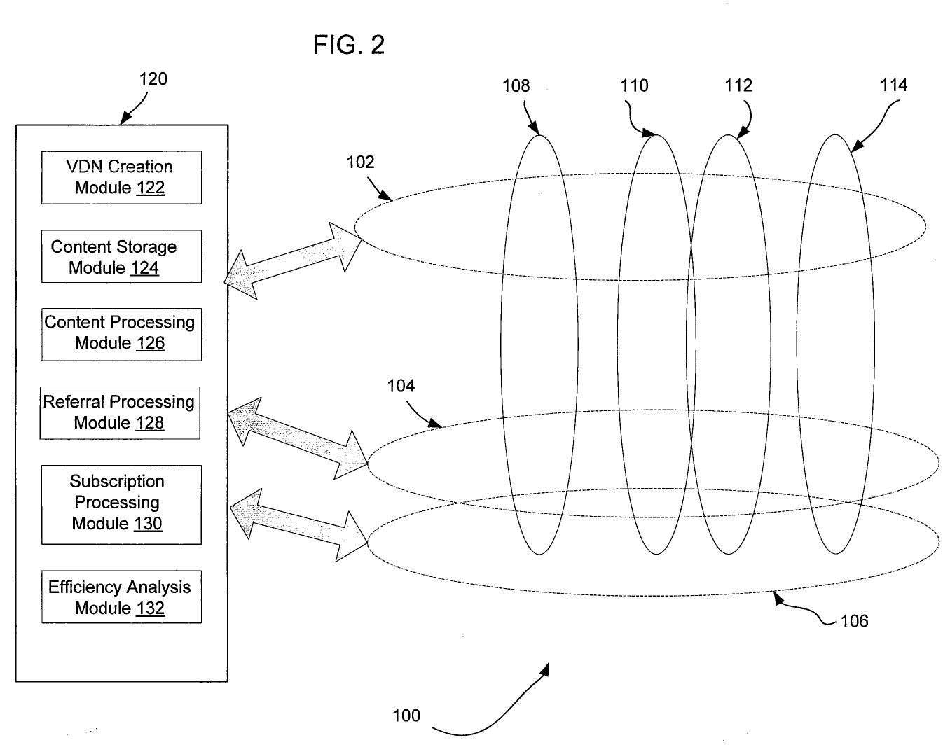

Now referring to FIG. 2, an embodiment of a virtual distribution network (VDN) system 100 illustrates a plurality of VDNs 102, 104, 106. Each of the VDNs 102-106 may include a number of subscribers for content distributed by that particular VDN. For example, the VDN 102 may distribute audio content including a plurality of motivational, inspirational speeches, excerpts, etc. On the other hand, the VDN 104 may distribute video content including a plurality of music files, samples of television programs, video content generated by subscribers of that particular VDN, etc. Similarly, the VDN 106 may distribute audio-visual files including video games, etc.

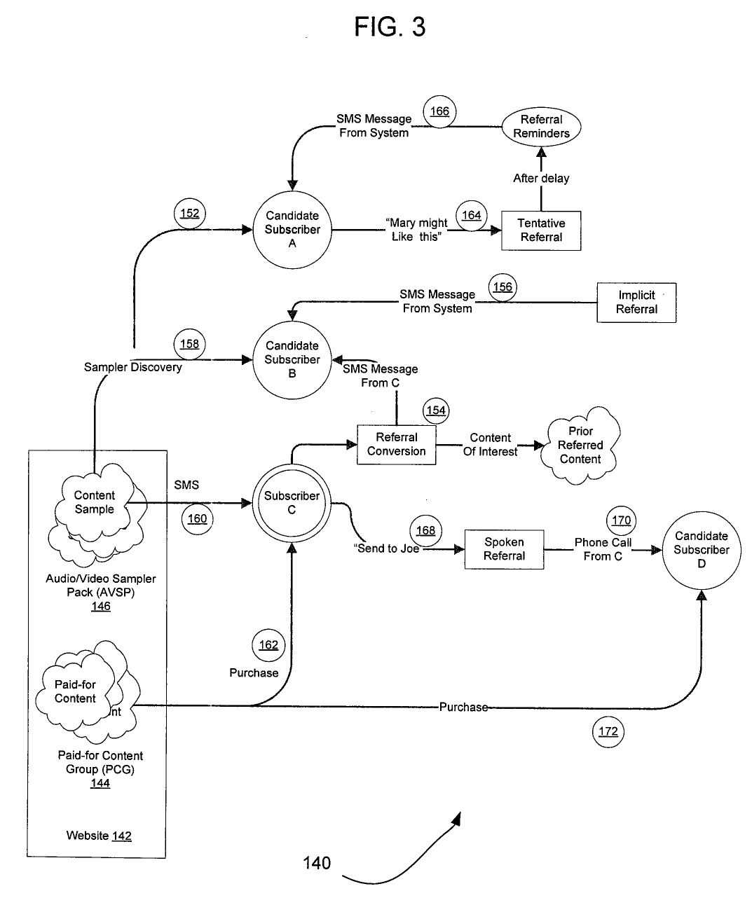

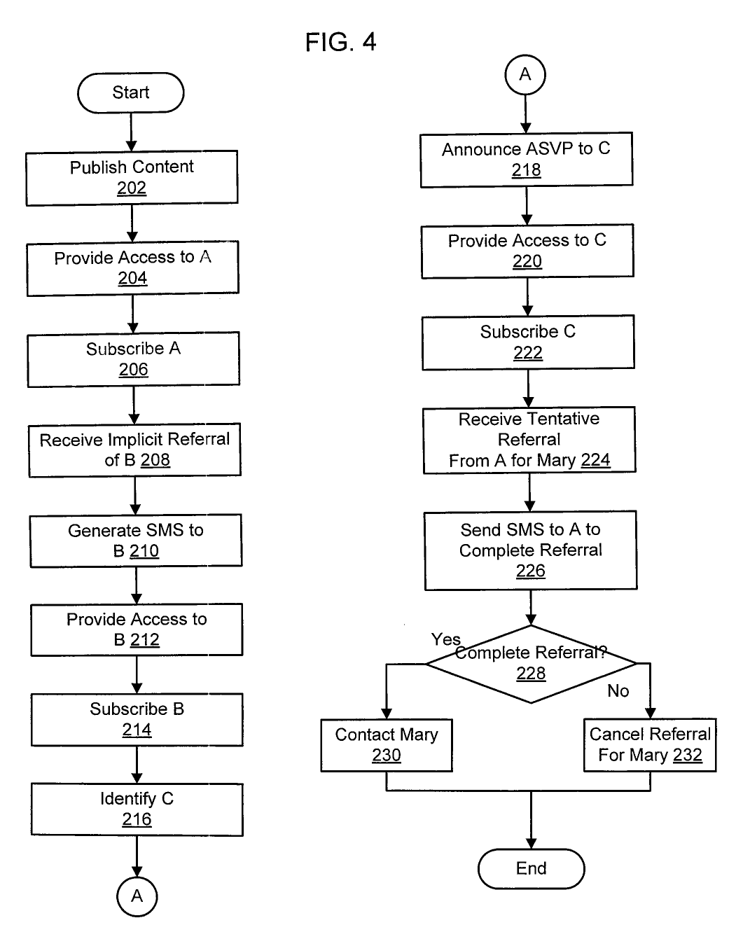

Each of the VDNs 102-106 may implement higher-level connections between the subscribers to that particular network. For example, the VDN 102 may not only distribute audio content between its subscribers, but it may also facilitate communication between its subscribers, including, creating blogs related to various content on the VDN 102, reviewing and referencing content to other members of the VDN 102, social networking between the members of the VDN 102, etc. The VDN system 100 may add a number of other VDNs and/or cease operating one or more of the existing VDNs. The creation and operation of the VDNs 102-106 are described in further detail in FIGS. 3-4 below.

The VDN system 100 illustrates each of the individual VDNs 102-106 to be built across a plurality of communication networks 108-114. The communication networks may be any of the existing communications networks or any other communication network based on other technology. For example, the network 108 may be a wireless communication network, the network 110 may be a plain-old-telephone system (POTS) network, the network 112 may be an Internet Protocol (IP) network, the network 114 may be a metropolitan area network (MAN), etc. As one of ordinary skill in the art will appreciate, the networks 108-114 may also overlap over each other, i.e., the MAN 116 may also operate as part of the IP network 112, etc. Moreover, one or more of the subscribers to any of the VDNs 102-106 may be on more than one of the communication networks 108-114. Each of the networks 108-114 may include one or more components of the network 10 of FIG. 1 and one or more of the several nodes of the network 10.

The VDN system 100 of FIG. 2 may also include a VDN server 120 that may be designed to create and manage the VDNs 102-106. The VDN server 120 may be implemented on any computing device, such as, the computing device 20 illustrated in FIG. 1. Some of the functionalities of the VDN server 120 are illustrated in FIG. 2 by different modules 122-132, wherein such modules may be implemented via software, hardware, firmware, or any combination thereof. Moreover, not all of the modules 122-132 have to be implemented in any given implementation and an alternate embodiment of the VDN system 100 may include a number of additional modules that are not disclosed herein. Similarly, one or more of the modules 122-132 may be implemented on different nodes of the network 10, i.e., for example, a database server on the network 10 may implement the content storage module 122, while a billing server located at a bank may implement the subscription-processing module 130, etc. Moreover, functionalities of one or more of the modules 122-132 may also be combined together in one module.

Now referring to the various modules 122-132, the VDN creation module 122 may create a new VDN based on a specific group of content files. For example, the VDN creation module 122 may receive an initial pool of candidate subscribers, who may be interested in receiving audio files related to business books, from a mailing list, from a marketing list, from interest surveys, etc. The VDN creation module 122 may create audio sample packs based on a number of business related audio files, and make them available to the candidate subscribers by publishing them at a website, or at a toll-free phone number where they can be reviewed. Alternately, the VDN creation module 122 may deliver such audio sample packs to the candidate subscribers via e-mail or other mechanism. The candidate subscribers may evaluate the audio sample packs of a particular VDN, evaluate conceptual basis of the operation of that particular VDN, and consider joining that VDN. Subsequently, upon receiving any interest from the candidate subscribers, the VDN creation module 122 may subscribe the interested candidate as a member of that particular VDN. Other mechanisms for initiating a VDN are described in further detail in FIGS. 3-4 below.

The content storage module 124 may store audio files, video files, and any other content that may be distributed over the VDNs 102-106. For example, a paid-for-content file, such as an audio file, received from a subscriber of the VDN 102, where the paid-for-content file is to be shared with other subscribers of the VDN 102, may be stored on the content storage module 124. The content storage module 124 may be designed specifically so that audio and video content may be searched and delivered to the subscribers at higher speeds. For, example, the content storage module 124 may store recently requested audio and video files in a random access memory (RAM) based database for faster access.

The content processing module 126 may process audio files, video files, and any other content that may be distributed or shared by the VDN system 100. For example, the content processing module 126 may convert an audio/video file to an audio/video sampler pack (AVSP), where the AVSP may be distributed to candidate subscribers, to existing subscribers, etc. The content processing module 126 may also attach information to an audio/video file or to an AVSP so as to facilitate its communication over a particular network and to facilitate its use by the subscriber. For example, if an AVSP is to be distributed over a relatively slow POTS network, the content processing module 126 may compress the AVSP to lower resolution level, whereas when the same AVSP is to be distributed over a relatively faster optical fiber based MAN, the AVSP content processing module 126 may enhance the AVSP by additional features, etc. Similarly, if a subscriber is using an MPEG player, the content processing module 126 may convert the AVSP into the MPEG format, or into any other suitable media format as selected by the subscriber. In an alternate example, the content processing module 126 may attach advertising content to the AVSP files based on identity of a subscriber, wherein such an advertising content may be targeted to subscribers in a specific target market. In yet another implementation, the content processing module 126 may also attach information regarding group incentives, employee incentives, etc. In an alternate embodiment, the content processing module 126 may convert audio content of an AVSP file into a language preferred by a target subscriber.

In an alternate embodiment the content processing module 126 may make any media content available to a potential customer by making the media content available to the potential customer via really simple syndication (RSS) technology, wherein the media content is automatically uploaded to a website of the potential customer.

The referral-processing module 128 may request members of an existing VDN to provide referrals for new members to that VDN. The subscribers may provide referrals in the form of phone numbers, e-mail addresses, etc., of the candidate subscribers. The referral-processing module 128 may use existing lines of social connections and common interests between existing subscribers and candidate subscribers to induce referrals from existing subscribers. For example, the referral-processing module 128 may allow a user to provide and e-mail address of a candidate subscriber and a message to that candidate subscriber, attach the message to an AVSP, and communicate the combined message and AVSP to that candidate subscriber. Similarly, the referral-processing module 128 may initiate and maintain an incentive program for existing subscribers to provide referrals, wherein, a monetary or other award may be provided to the existing subscribers providing the referrals.

Alternately, the referral-processing module 128 may allow a user to generate a referral by telephone call. In such a case, the referral-processing module 128 receives a referring phone call from an existing subscriber and generates a call to a candidate subscriber using the automatic number identification (ANI) of the referring subscriber. As a result, the candidate subscriber will seem to have received a call from the referring subscriber. In such a case, the call's content may be a message from the referring subscriber together with an audio sample file. If the phone number of the candidate subscriber is identified as a cellular phone capable of receiving a short message service (SMS) message, the referral-processing module 128 may generate an SMS message on behalf of the referring subscriber, attach a sample pack to the SMS message, and send the combined message to the candidate subscriber.

Similarly, the referral-processing module 128 may receive an e-mail referral from an existing subscriber in the form of an e-mail address of a candidate subscriber, generate an outgoing e-mail message to the candidate subscriber on behalf of the referring subscriber, and attach any AVSP and/or an invitation to join a VDN to the e-mail message. Alternately, the referral-processing module 128 may also generate such a message to the candidate subscriber on behalf of the VDN. In an alternate embodiment, the referral-processing module 128 may also provide a temporary user identification and password to the candidate subscriber to sample a number of other content and AVSPs available on a given VDN.

Moreover, a number of other referral processing methods may be used to accommodate referrals from existing subscribers, some of which are described in further detail below:

(1) Web Referrals: Endorsement of a piece of content to a specific candidate subscriber, captured on a web application designed for capturing content referrals.

(2) Spoken Referrals: Endorsement of a piece of content to a specific subscriber candidate, captured in spoken form just after review of the piece of content and known to the system as a uniquely identifiable subscriber candidate, such as, a member of a different VDN, etc.

(3) Spoken Group Referrals: An aggregation of spoken referrals, enacting the same type of explicit endorsement through the spoken use of a named group, such as “close friends,” “book club,” etc., set up in advance by the subscriber on a website or on an automated speech application.

(4) Tentative Referrals: Private notes by a subscriber, captured in spoken or textual form as a reminder for later referrals, and associated with specific piece of content.

(5) Referral Reminders: A message to a subscriber regarding a pending tentative referral.

(6) Referral Conversions: A conversion of a tentative referral into a completed referral, wherein the system is not able to attempt to use at least one of the several methods described above related to delivering the referred content.

(7) Implicit Referrals: If two subscribers, A and B, are judged by the VDN system 100 to share similar survey responses and/or behavior related to accessing content within a VDN, then either the VDN system 100 or the subscriber A may implicitly refer a piece of content to B using a statement regarding that piece of content, the statement made either A or by the VDN. This is done based on the understanding that given B's phone based and/or web based behavior being similar to that of A, B is likely to appreciate the same content that A has accessed.

While the list above describes some of the referral methods used by the referral-processing module 128, as one of ordinary skill in the art will appreciate, a number of other referral methods may be also be employed. By allowing an extensive array of referral capabilities to the subscribers of various VDNs, the referral-processing module 128 allows viral growth of such VDNs.

Now referring back to FIG. 2, the subscription-processing module 130 allows existing subscribers and candidate subscribers to subscribe to a VDN. The subscription processing module 130 may allow a subscriber to purchase any of a one time use subscription, an unlimited use subscription, a limited period use subscription, a limited content use subscription, a combination of one or more of these subscriptions, etc. Alternately, the subscription-processing module 130 may also provide a candidate subscriber a free trial subscription for some content or AVSP files. Moreover, to facilitate generation of more referrals, the subscription-processing module 130 may also provide free subscription to a subscriber if the subscriber generates a certain number of referrals, etc. Because each VDN provides access to a number of subscribers with a focused interest area, such group of subscribers may be very useful for an advertiser to target certain products. Therefore, in yet another embodiment, the subscription-processing module 130 may provide free subscriptions to a number of subscribers on behalf of an advertising entity and allow the advertising entity to place advertises to the free content subscribers.

The subscription-processing module 130 may also use an automated speech based interface, where a candidate subscriber can provide payment information in the form of credit card number, etc., to purchase subscription to a VDN. Alternatively, an Internet based e-commerce platform may also be used to accomplish a subscription purchase transaction. Moreover, the subscription-processing module 130 may also provide subscription to a user as a reward for providing a certain number of successful referrals.

In an alternate embodiment, the subscription-processing module 130 may facilitate loaning of a purchased content from one subscriber to another wherein such loaning of content may be covered by fair use. If necessary, the subscription-processing module 130 may ensure that the loaner subscriber looses access to the loaned content during the period of the loan.

The efficiency analysis module 132 monitors efficiency and other operating metrics of one or more of the VDNs 102-106. For example, a VDN may be analyzed via aggregation of one or more of the following content distribution efficiency metrics (CDEM) for each subscriber in a VDN:

(1) Consumption Index: An amount of adoption of content associated with a VDN in such a way as to incur expense to the VDN system 100 in delivering the content to the subscriber.

(2) Connector Index: An amount of referral activity of a VDN's content to other subscribers or to candidate subscribers.

(3) Purchase Index: An amount of fees paid by the subscriber to access any content associated with a VDN.

As one of ordinary skill in the art will appreciate, in an alternate embodiment of the VDN system 100, additional metrics may be provided. The efficiency analysis module 132 may use the scores of subscribers to a VDN to determine efficiencies of VDNs. For example, a particular VDN with value of a statistical representative of the subscriber scores, such as an average, a median, etc., above a given threshold may be identified as an efficient VDN (EVDN). Such EVDNs may be targeted by the VDN system to distribute additional content.

Now referring to FIG. 3, a flow diagram 140 illustrates the functioning of the VDN system 100 using a content distribution and referral process. The flow diagram 140 illustrates a website 142 having published content in the form of paid-for-content 144 and audio/visual sample packs (AVSPs) 146. As discussed above, the paid-for-content 144 and content samples 146 may be stored on the content storage module 124 and published at the website 142 by the content processing module 126 of the VDN system 100. The website 142 may also be enabled by the subscription processing module 130 to undertake sales transactions for the AVSPs 146 or for the paid-for-content 144.

At 152, the VDN creation module 122 may initiate a VDN's creation and content distribution process by publishing one or more audio and video files representative of the paid-for-content 144 and/or AVSPs 146 on the website 142. A candidate subscriber, such as a subscriber A, may discover and evaluate such published content and decide to become a member of the VDN.

At 154, a subscriber C, who may be a subscriber of an alternate VDN, may refer a subscriber B to the VDN system 100 as having an interest in any content similar to that published on the website 142. As a result, at 156, the VDN system 100 may initiate an implicit referral of the AVSPs 146 to subscriber B using an SMS message, referring subscriber B to the website 142. Prompted by the implicit referral, at 158 subscriber B may review the AVSP 146 on the website 142 and decide to become a member of the VDN.

At 160, the referral-processing module 128 of the VDN system 100 may announce the publication of the AVSPs 146 to the subscriber C, who had already indicated interest in content similar to the AVSPs 146, and invite C to review the AVSPs 146 on the website 142. C may respond positively to the invitation and at 162, C may purchase the paid-for-content 144 from the website 142.

Subscriber A may listen to the AVSPs 146 and the paid-for-content 144 and decide that his/her friend Mary may be interested in such content. Therefore, A may, via a voice message, tentatively refer Mary to the referral-processing module 128. At 164, the referral-processing module 128 may decipher contact information about Mary by using a voice recognition program. Because Mary is referred to the VDN 100 on a tentative basis, the referral-processing module 128 waits for a predetermined period to receive completed referral of Mary from subscriber A. After the predetermined period, at 166, the referral-processing module 128 may ask subscriber A to either identify Mary as a completed referral or to cancel the tentative referral of Mary.

At 168, subscriber C may explicitly refer the content on the website 142 to a candidate subscriber D via a spoken referral. At 170, the referral-processing module 128 may initiate an outbound call to the candidate subscriber D with the referring subscriber C's ANI, thus providing the candidate subscriber D an access to the AVSPs 146 via phone. At 172, the candidate subscriber D may review the AVSPs 146 using a phone and decide to subscribe to the VDN.

Some of the components of the content distribution and referral process of FIG. 3 are also illustrated by a flowchart 200 in FIG. 4. Note that the flowchart 200 shows the content distribution and referral process by example only, therefore, not all the blocks of the flowchart 200 are necessary for any given implementation of the content distribution and referral process. Moreover, although various blocks of flowchart 200 are described as software blocks, in an alternate embodiment, some of these blocks may be implemented by hardware, firmware, etc.

A block 202 may initiate a VDN's creation and content distribution process by publishing one or more audio and video files representative of the paid-for-content 144, and/or the AVSPs 146 on the website 142. A block 204 may provide subscriber A an access to the published content to subscriber A by, for example, sending an e-mail invitation to subscriber A. The e-mail address of subscriber A may be received from a listing service, etc. A block 206 may subscribe A to the VDN.

A block 208 may receive an implicit referral for candidate subscriber B, in response to which, a block 210 may generate an SMS message inviting candidate subscriber B to review the content on the website 142. If the candidate subscriber B determines to accept the invitation to review the content, a block 212 may provide candidate subscriber B an access to the content. If candidate subscriber B determines to join the VDN, a block 214 may subscribe B to the VDN.

A block 216, with help from an existing subscriber, may identify candidate subscriber C as having interest in content on website 142. Subsequently, a block 218 may announce an ASVP to candidate subscriber C by telephone. The block 218 may announce the ASVP to C by using the ANI of the referring subscriber so that C would think that the invitation to sample the ASVP is provided by the referring subscriber. After reviewing the ASVP, if C is interested in content, a block 220 provides access to C to review the content on website 142. Subsequently, if C is interested, a block 222 may subscribe C to the VDN. At this point the block 222 may reward the referring subscriber for providing a successful referral.

A block 224 may receive a tentative referral from subscriber A for a friend Mary as a potential subscriber. The block 224 may save the tentative referral in memory. After a predetermined time, block 226 may generate a reminder SMS message to subscriber A to provide a completed referral of Mary. A block 228 may determine if subscriber A has provided any completed referral of Mary or not. If such a completed referral is received, a block 230 may contact Mary with an AVSP, otherwise, a block 232 may ask subscriber A to cancel the tentative referral of Mary.

As one of ordinary skill in the art would know, the order of one or more blocks of the flowchart 200 may be altered and one or more blocks of the flowchart 200 may also be processed in parallel form. Similarly, additional blocks may be added at any point in the flowchart 200. Moreover, each of the blocks of the flowchart 200 may be implemented as part of various components of the modules 122-132 of the VDN system 200.

In view of the many possible embodiments to which the principles of this patent may be applied, it should be recognized that the embodiments described herein with respect to the drawing figures are meant to be illustrative only and should not be taken as limiting the scope of patent. For example, for performance reasons one or more components of the method of the present patent may be implemented in hardware, rather than in software. Therefore, the patent as described herein contemplates all such embodiments as may come within the scope of the following claims and equivalents thereof.

What is claimed is:

1. A method of creating a virtual distribution network for distributing content over a plurality of networks, the method comprising:
electronically publishing the content on one of the plurality of networks;
generating a sample of the content;
communicating the sample to a plurality of potential subscribers using the plurality of networks;
receiving a request from the one of the plurality of potential subscribers to use the content;
receiving subscription information from the requesting potential subscriber;
processing the subscription information; and
providing the content to the requesting potential subscriber upon successful processing of the subscription information.

2. The method of claim 1 further comprising, subscribing the requesting potential subscriber to the virtual distribution network.

3. The method of claim 1, wherein the content is received from one of a plurality of existing subscribers of the virtual distribution network.

4. The method of claim 1, further comprising:
receiving a referral for a potential subscriber from one of the plurality of existing subscribers; and making the sample available to the referred potential customer.

5. The method of claim 4, wherein making the sample available to the referred potential customer comprises making the sample available to the referred potential customer over at least one of: (1) a wireless phone; (2) e-mail; (3) a landline telephone; (4) a personal-data-assistant; and (5) portable media player.

6. The method of claim 4, wherein making the sample available to the referred potential customer comprises making the sample available to the referred potential customer via really simple syndication (RSS) technology to a website of the referred potential customer.

7. The method of claim 5 further comprising, providing a reward to the referring subscriber upon successful subscription of the referred potential customer.

8. The method of claim 1, further comprising:
receiving a loaned content pack from a member of the virtual distribution network;
generating a sample pack for the loaned content pack;
electronically publishing the sample pack on the network;
receiving a request for the loaned content pack from another member of the VDN;
charging a debit to a subscription account of the another member of the VDN;
making the sample pack available to the another member; and
providing a credit to the subscription account of the loaning member.

9. The method of claim 1, wherein the content is at least one of: (1) audio content; (2) video content; (3) text content; and (4) computer code.

10. The method of claim 1, further comprising analyzing the VDN using at least one of: (1) a consumption index; (2) a connector index; and (3) a purchase index.

11. The method of claim 9, further comprising comparing at least one of: (1) the consumption index with a consumption index threshold; (2) the connector index with a connector index threshold; and (3) the purchase index with a purchase index threshold, to determine efficiency of the VDN.

12. A method of creating a virtual distribution network for distributing content over a network, the method comprising;
receiving the content from a subscriber of the virtual distribution network;
generating a sample of the content;
electronically publishing the content and the sample on the network;
providing access to a plurality of potential subscribers to review the sample;
receiving a request from one of the plurality of potential subscribers to use the content, the request including a referral from a referring subscriber of the virtual distribution network;
verifying the referral from the one of the plurality of potential subscribers; and
if the referral is verified, providing the sampler to the one of the plurality of potential subscribers.

13. The method of claim 12, further comprising:
receiving subscription from the one of the plurality of potential subscribers;
providing the content to the one of the plurality of potential subscribers upon successful subscription; and
providing a credit to the referring subscriber.

14. The method of claim 12, wherein the referral is at least one of: (1) a spoken referral; (2) a tentative referral; (3) an implicit referral.

15. The method of claim 14, wherein the implicit referral is determined by comparing at least one of: (1) survey responses by one or more subscribers of the VDN; (2) comparing content access activity of the one or more subscribers of the VDN; (3) comparing content usage activity of one or more subscribers of the VDN; (4) comparing content purchase activity of one or more subscribers of the VDN; and (5) comparing demographic characteristics of one or more subscribers of the VDN.

16. A processor readable medium having encoded thereupon a processor-readable program code which when executed causes a processor to implement a method for creating a virtual distribution network (VDN) for distributing content stored on the processor readable network over a plurality of networks communicatively attached to the processor, the method comprising:
electronically publishing the content on one of the plurality of networks;
generating a sample of the content;
communicating the sample to a plurality of potential subscribers using the plurality of networks;
receiving a request from the one of the plurality of potential subscribers to use the content;
receiving subscription information from the requesting potential subscriber;
processing the subscription information; and
providing the content to the requesting potential subscriber upon successful processing of the subscription information.

17. The processor readable medium of claim 16, wherein the content is at least one of: (1) a paid-for-content; and (2) free content.

18. The processor readable medium of claim 16, further comprising a VDN analysis program stored on the computer readable medium for generating a VDN consumption index; (2) a VDN connector index; and (3) a VDN purchase index.

19. A virtual distribution network (VDN) system for managing a VDN over a plurality of communication networks, the system comprising:
a VDN creation module adapted to (1) electronically publish media content on one of the plurality of communication networks, (2) to generate a sample of the media content, and (3) to communicate the sample to a plurality of potential subscribers;
a content storage module adapted to store the media content and the sample on one of the plurality of communication networks;
a content processing module adapted to convert the sample and the media in a format communicable to and usable by the plurality of potential subscribers; and
a subscription processing module adapted to (1) receive a request from the one of the plurality of potential subscribers to use the content, (2) receive subscription information from the requesting potential subscriber, and (3) process the subscription information.

20. The VDN system of claim 19, further comprising a referral processing module adapted to (1) receive a referral from a subscriber of the VDN; (2) generate an outgoing call to the referred subscriber on behalf of the referring subscriber; and (3) provide sample to the referred subscriber via the outgoing call.

21. The VDN system of claim 20, further comprising an efficiency processing module adapted to calculate (1) a VDN consumption index; (2) a VDN connector index; and (3) a VDN purchase index.

22. The VDN system of claim 21, wherein each of the VDN creation module, the content storage module, the content processing module, the referral processing module, the subscription processing module and the efficiency analysis module are residing on different nodes of a communication network.
